(19) United States
(12) Patent Application Publication
(10) Pub. No.: US 2011/0113694 A1
(43) Pub. Date: May 19, 2011

(54) SLIDING WALL

(75) Inventors: Jean-Pierre Douche, Le Plessis Brion (FR); Rene Poix, Noyon (FR)

(73) Assignee: SAINT-GOBAIN GLASS FRANCE, COURBEVOIE (FR)

(21) Appl. No.: 13/001,057

(22) PCT Filed: Jun. 16, 2009
(86) PCT No.: PCT/FR2009/051144

§ 371 Date: Dec. 23, 2010

(30) Foreign Application Priority Data
Jul. 3, 2008 (FR) 0854538

(51) Int. Cl. E06B 3/46; E05D 15/06

(52) U.S. Cl. 49/425; 49/404

(57) ABSTRACT

A sliding wall including at least one panel configured to slide and a multiple glazing unit that includes at least two glass sheets separated by at least one basically flat interlayer fixed via one of its faces to edge faces of the glass sheets on at least part of a periphery of the glazing unit. The glazing unit has no interlayer along at least part of one of its edges to create a lateral opening, a space between the two glass sheets forming a receiving area for the panel configured to slide in by being introduced through the lateral opening.

The invention relates to a sliding wall used in construction work and more particularly for interior use.

Document WO 2007/077374 has already disclosed a glass wall designed to be used as a partition comprising at least two insulating glazing units, characterized in that each glazing unit comprises at least two glass sheets separated by a gas space and joined together by at least one basically flat interlayer that is fixed via one of its faces to the edge faces of the glass sheets, and in that the glazing units are fixed together by fixing means which engage with the interlayers of the glazing units facing each other.

The insulating units used to construct such a wall are completely novel and could be described as new-generation glazing units. Indeed, their interlayer is on the outside of the glazing unit, along the edge faces of the glass sheets, rather than between the glass sheets as in traditional insulating glazing units.

This type of new-generation glazing unit has much greater resistance to pressure normal to the surface of the glazing unit than has a conventional glazing unit with the interlayer on the inside, between the glass sheets. The reason for this is that this arrangement of the interlayer, accompanied by a interlayer suitable for buckling resistance, ensures that the glazing unit behaves monolithically, without the risk of one glass sheet sliding relative to the other when the glazing unit is in the installed position, that is to say when resting on its edge face.

The combination of these new-generation glazing units to form a glass wall thus provides all the properties of mechanical strength and stiffness of existing building walls, while offering the advantage of continuous transparency to light across the whole of its surface.

Document WO 2007/077374 indicates the possibility of using the glass wall as a sliding element. The wall slides sideways relative to another wall in the manner of a traditional sliding door.

It is an object of the invention to provide a sliding wall using another form of construction.

According to the invention, the sliding wall comprises at least one panel able to slide and a multiple glazing unit that comprises at least two glass sheets separated by at least one basically flat interlayer fixed via one of its faces to the edge faces of the glass sheets on at least part of the periphery of the glazing unit, said wall being characterized in that the glazing unit has no interlayer along at least part of one of its sides in order to create a lateral opening, the space between the two glass sheets forming a receiving area for the panel designed to slide by being introduced in through the lateral opening.

Clearly, when constructing a wall in communication with the exterior of a building, it is imperative that the glazing units adequately fulfill their waterproofing function. But in the case of the interior of a building, there is no requirement that such a glass wall meet the waterproofing requirements normally imposed on insulating glazing units. Consequently the glazing unit can be open along part of one of its sides and hence not waterproof, without this being a problem.

According to one feature connected with the multiple glazing unit considered in the wall of the invention, the width of the interlayer extends across the width of the glazing unit and is limited to the outermost edges of the edge faces of the glass sheets and does not cover the outer faces of said glass sheets, there being no need for the interlayer to be inserted between the glass sheets because of its adequate buckling stiffness, preferably at least 400 N/m.

For details of the construction of the multiple glazing units used in the wall of the invention, the reader may refer particularly to patent applications WO 01/79644 and WO 03/040507.

The multiple glazing unit of the invention is thus partly open along one of its edges so that its interior space acts advantageously as a housing for a sliding panel. At the same time, owing to the type of interlayer used and the arrangement of this interlayer, it constitutes in itself a self-supporting system. There is therefore no need to provide the glazing unit with a supporting frame such as that for a window: the glazing unit acts on its own as a wall panel.

A wall using such a glazing unit further optimizes the penetration of natural light into the rooms of the building, giving maximum visibility while yet exhibiting the required stiffness and strength.

In one embodiment of the invention, the wall comprises two multiple glazing units arranged at a distance from each other in a coplanar manner and in such a way that their respective lateral openings face each other, and the panel that is able to slide is arranged between the multiple glazing units and is designed to be moved into either of the glazing units through the corresponding lateral opening.

The multiple glazing unit of the wall of the invention is preferably fixed but may be sliding.

The multiple glazing unit, whose interior space acts as the receiving area, is made of glass. However, the panel which is designed to slide into the receiving area is a rigid panel whose material is chosen to suit the general design of the wall. Without implying any limitation, it may be a glass panel, such as a monolithic glass substrate, and this glass panel may be transparent, translucent, mirror-finished, colored, or decorated by screen printing or sand blasting. The rigid panel may be made of another material, such as painted or stained wood.

It is also conceivable for the multiple glazing unit, like the panel designed to slide when made of glass, to be an active glazing unit such as a liquid-crystal glazing unit which becomes opaque when supplied with electricity.

According to one feature, the wall comprises sliding means which consist of at least one track arranged in the receiving space of the multiple glazing unit, at least one continuation rail arranged outside of the glazing unit and level with the track, and rolling means that are fixed to the panel designed to slide and are able to engage with the track and with the continuation rail.

According to another feature, in order to guide the panel designed to slide properly into the receiving space, the wall, particularly the multiple glazing unit, comprises in the receiving space guiding means.

The guiding means are advantageously on the opposite side from the track and consist for example of at least two projections which are spaced apart and facing each other on the inside face and across the width of the interlayer.

In one example of an embodiment of the glazing unit, the track may be located along the horizontal top of the glazing unit, when the wall is in the installed position, whereas the guiding means are associated to the horizontal bottom edge of the glazing unit when the wall is in the installed position.

The terms “top” and “bottom” are used in the following description to refer to the arrangement of the elements of the wall with respect to each other when the wall is in its installed vertical position.

The sliding means and the guiding means are located at the top and/or bottom of the wall, depending on the desired design of the wall. The sliding means are however usually located opposite from the guide means.

According to another feature, the track in the receiving space is fixed to the inside faces of the glass sheets and optionally alongside the glazing unit interlayer, and/or is fixed to a profile attached to the glass sheets around the periphery of the glazing unit.

In another embodiment of the wall of the invention, particularly where the panel designed to slide has a height smaller than the receiving glazing unit, the wall has a fixed element which is butted against and coplanar with the receiving multiple glazing unit and which supports the continuation rail external to the glazing unit with which the sliding panel engages when the latter is slid externally to the multiple glazing unit.

The fixed element preferably consists of another multiple glazing unit comprising a flat interlayer arranged on the outside of and on all the periphery of the glazing unit, and fixed to the edge faces of the glazing unit, said element being butted against the receiving multiple glazing unit on the edge face of the glazing unit and at the edge of the glazing unit that comprises the lateral opening; the receiving multiple glazing unit has its lateral opening on only part of its edge, and the rest of the edge being closed by the interlayer, the fixed element being fixed to the receiving multiple glazing unit via their respective interlayers at the edge where the glazing unit has the lateral opening.

In another embodiment, the wall is designed to be installed between the floor and the ceiling of a building room, the panel then extending the full height from the floor to the ceiling, and the continuation rail external to the receiving glazing unit being designed to be fixed to the ceiling.

Lastly, such a wall will be used particularly to form all or part of an internal partition for a building room. It may also form a cupboard door.

Other features and advantages of the invention will now be described with reference to the drawings, in which:

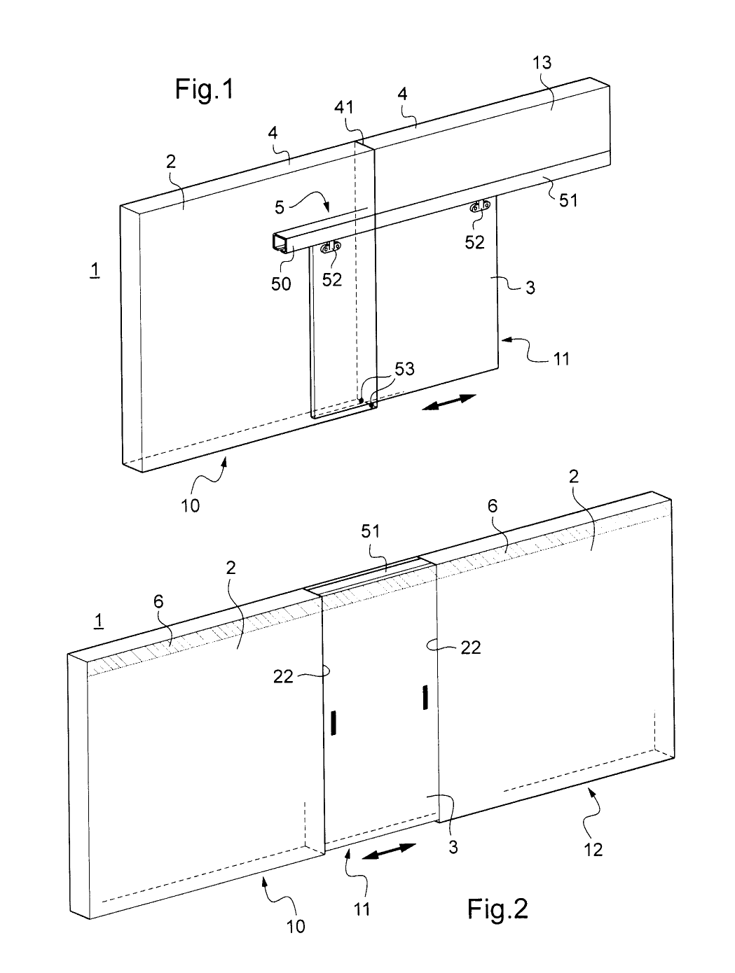

FIG. 1 is a diagrammatic perspective view of a sliding wall in one embodiment of the invention;

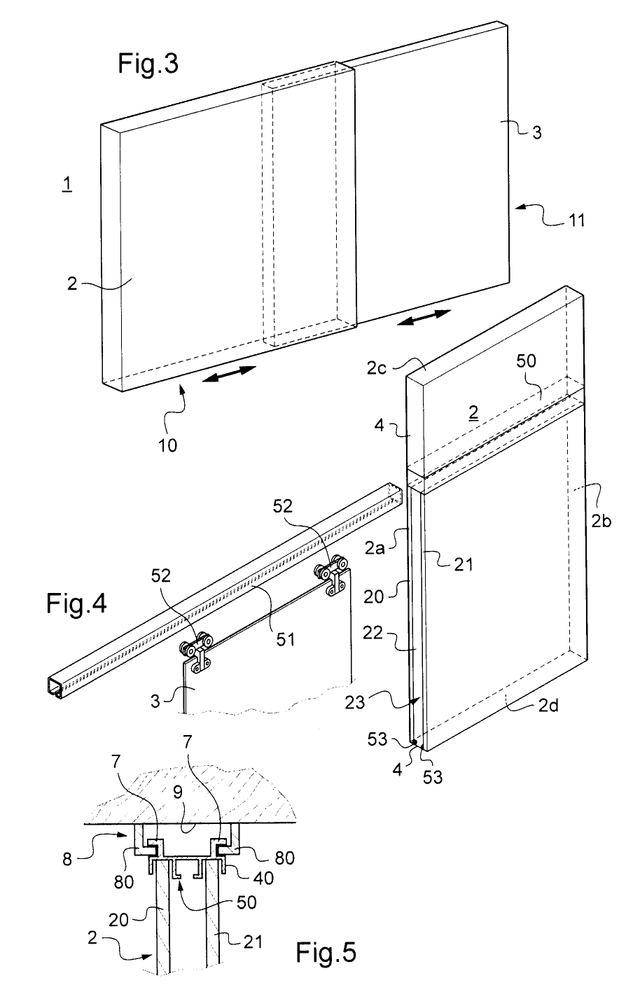

FIGS. 2 and 3 are diagrammatic perspective views of two other embodiments of a sliding wall of the invention;

FIG. 4 is an exploded perspective view of part of the wall seen in FIG. 1; and

FIG. 5 is a partial cross section through the receiving and sliding glazing unit of the embodiment seen in FIG. 3.

For the sake of clarity of the figures, they are not drawn to scale.

FIG. 1 shows a wall 1 which is called a sliding wall because at least part of it is able to slide. This wall may for example be an interior partition of a building, which separates two rooms and which it is wished to be able to open in the manner of a sliding door.

The wall of the invention has at least two panels 10 and 11 which are arranged, when the wall is closed, in line with each other, that is to say coplanar, in contrast to the prior art in which the panels overlap at one of their ends. To provide the coplanar sliding wall of the invention, one of the panels enters into the other panel in the open position.

In the embodiment shown in FIG. 1, the panel 10 is fixed while the panel 11 is sliding.

The wall comprises according to the invention at least one multiple receiving glazing unit 2 which forms the first panel 10, and a rigid panel 3 forming the second panel 11 and designed to slide into the multiple glazing unit 2.

In the embodiment shown in FIG. 2, the wall comprises three panels 10, 11 and 12. The two panels 10 and 12 are fixed, each consisting of a multiple receiving glazing unit 2, and are arranged on either side of the intermediate sliding panel 11, which is able to slide into either receiving glazing unit 2.

The embodiment shown in FIG. 3 illustrates a sliding wall with two panels 10 and 11 as already illustrated in FIG. 1. The panel 10 is a multiple receiving glazing unit 2, while the other panel is a rigid panel able to slide into the glazing unit 2. The difference is, the receiving multiple glazing unit 2 is also able to slide.

In all embodiments, the receiving multiple glazing unit 2 comprises two sheets of glass 20 and 21 separated by at least one flat interlayer 4 which extends to at least part of the periphery of the glazing unit.

The interlayer 4 is positioned outside of the glass sheets without being engaged in the inner space of the glazing unit between the glass sheets. Via one of its faces it is fixed to the edge faces of the glass sheets and extends across the width of the sheet in such a way as to be limited to the outermost edges of the edge faces of the glass sheets and not to cover the exterior faces of said glass sheets.

This interlayer consists of one or more flat butt-jointed profiles having a buckling resistance per unit length of at least 400 N/m. The thickness of the flat profile is preferably no more than 2 mm. Details of construction are given in particular in patent application WO 03/040507. An example of a flat profile is a 0.5 mm thick aluminum, or a 0.3 mm thick stainless steel strip.

The glazing unit 2 (FIG. 4) is a four-sided parallelepiped with two opposite vertical lateral edges 2a and 2b and two opposite horizontal edges, a top edge 2c and a bottom edge 2d when the glazing unit is in the installed position in the wall. The interlayer 4 in this case runs around one lateral edge and the top and bottom edges of the glazing unit, the glazing unit having no interlayer along all or part of the other lateral edge in order to allow for a lateral opening 22.

The lateral opening 22 allows access to the space 23 inside the glazing unit between the two glass sheets, this space forming the receiving area into which the rigid panel 3 slides.

To space the glass sheets apart, the interlayer 4, which in the present case is a flat strip on the outside of the internal space of the glazing unit, can be combined in the peripheral continuity of the glazing unit with an insert placed against the edge faces of the glazing unit between the glass sheets in the manner of a normal spacer. The insert may advantageously include functional parts. The interlayer 4 alone or combined with another type of spacing means must extend around at least three edges and at least two corners of the glazing unit to give the glass sheets mechanical unity and give the glazing unit sufficient stiffness such that it corresponds to the stiffness of a monolithic sheet.

To finish the glazing unit from the aesthetic point of view, the peripheral parts of the glazing unit not covered by the interlayer 4 or other spacing means, but not including the lateral opening 22, may be closed by any other type of closure means fitted to the edge faces and/or main faces of the glass sheets, such as the profile bearing the reference number 40 in FIG. 5 described later.

The rigid panel 3 provided in the wall according to the invention is in this case by way of example a monolithic glass. The whole of the wall is thus glass for total transparency.

In a variant, the rigid panel 3 may for example be made of wood so as to form with the multiple glazing unit a semi-transparent wall, the material of the panel being chosen specifically for the design of the wall.

To allow the panel 3 of the wall to slide, the wall 1 has sliding means 5 (FIGS. 1 and 4) which are made up of a track 50 arranged in the receiving space 23 of the multiple glazing unit 2, a continuation rail 51 arranged outside of the glazing unit and in line with the track 50, and a rolling system 52, such as rollers, mounted on the rigid panel 3.

The rolling system 52 is preferably located at the top of the panel. Another rolling system is not necessarily required at the opposite bottom edge of the panel.

Similarly, a single track 50 fitted to the glazing unit and which therefore engages with the rolling system 52 is sufficient. This track may for example be fixed to the inside faces of the glass sheets 20 and 21 at the appropriate height relative to the height of the rigid panel 3.

As a variant, the track 50 fitted to the glazing unit may be fixed to the interlayer 4 or closing means 40 which are located for example at the horizontal top edge of the glazing unit (FIG. 5).

Guiding means 53 are advantageously provided for the receiving multiple glazing unit 2 so that the panel 3 is introduced easily into the receiving space 23.

Of course, the sliding means 5 and the guiding means 53 may be located at the top and/or bottom of the wall depending in particular on the desired design of the wall.

In the example shown in FIG. 1, the wall corresponds to a height from floor to ceiling of a room. The receiving multiple glazing unit 2 is fixed: like an ordinary partition, its height corresponds to the height from floor to ceiling of the room, while the rigid panel 3 has a lower height corresponding to a typical height for a door. The location for the track 50 of the glazing unit is thus lower than the top edge of the glazing unit corresponding to the ceiling. Because of this, the continuation rail 51 outside of the glazing unit which must be maintained at the same level as the track 50 is supported by an element 13, and this elements also fills up the missing height from the top of the panel 3 to the ceiling.

The lateral opening 22 of the receiving multiple glazing unit 2 is the same height as the panel 3, the glazing unit being closed along its edge face by the interlayer 4 above its lateral opening.

The element 13 is advantageously glass, and may be a multiple glazing unit similar to the receiving multiple glazing unit 2, but with the same type of interlayer 4 running all the periphery of the glazing unit. In this way the receiving glazing unit 2 and the element 13 will give the appearance of an unbroken wall.

The element 13 is fixed to the multiple glazing unit 2 by joining together, using for example an adhesive 41, the respective interlayers 4 of the element 13 and a glazing unit 2.

At the opposite end from the receiving glazing unit 2, the element 13 is butted and fixed to a beam or wall (not shown) depending on the disposition of the wall in the room.

In the example depicted in FIG. 2, the wall corresponds to a floor-to-ceiling height of a room. The receiving multiple glazing units 2 and the panel 3 all have a height equivalent to the floor-to-ceiling height. The panel 3 can slide into either of the receiving glazing units.

The sliding means 5 are preferably arranged at the top of the wall and may for example be hidden on either side of the wall by an opaque strip 6. This strip may be a screen print applied directly to the glass of each panel 10, 11, 12, or may be a separate element at the periphery of the outer faces of the wall by being attached to the ceiling.

In the example shown in FIG. 3, the wall 1 is a cupboard door. Both panels 10 and 11 can slide. The panel 11, which is formed by the monolithic panel 3, slides into the panel 10 formed by the receiving glazing unit 2.

FIG. 5 shows in more detail the sliding system of the receiving glazing unit 2 illustrated in FIG. 3. Rolling means 7 are fitted to one of the peripheral outer edges of the glazing unit (the top edge) and engage with a rolling rail 8 fixed for example to the ceiling 9.

The rolling means 7 are supported by a profile 40 which straddles and is connected mechanically to the glass sheets 20 and 21 of the glazing unit. The mechanical fixing of the profile 40 is only on the outside of the glazing unit without requiring anything to project into the interior of the glazing unit, between the glass sheets. Examples of fixing methods, which may or may not be combined, include adhesive bonding to the outside faces of the glass sheets, blind holes (a non-through hole in each glass sheet) with fixing by means of an expansion plug, or alternatively drilling all the way through and fixing with a screw with a head ground flat so as to be coplanar with the inside face of the glass sheet.

Facing away from the glass sheets, therefore, the profile 40 is equipped with the rolling means 7 of roller type which engage with angle brackets 80 forming the running rail 8 to allow the glazing unit 2 to be slid.

The profile 40 also advantageously forms on the inside of the glazing unit the support means for the track 50 in which the other panel 11 is designed to slide.

Thus, the multiple glazing unit described above, comprising two separated glass sheets with spacing means formed principally by a flat interlayer outside of the interior space of the glazing unit, gives the glazing unit mechanical stiffness and is minimally intrusive and its lateral opening allows a panel to be inserted between its glass sheets. The novel receiving function offered by such a glazing unit makes it possible to produce a completely clean sliding wall or door, without any supporting frame, and presenting a unified appearance because of its co-planarity in the closed position.

1-11. (canceled)

12. A sliding wall comprising:
at least one panel configured to slide; and
a multiple glazing unit that comprises at least two glass sheets separated by at least one basically flat interlayer fixed via one of its faces to edge faces of the glass sheets on at least part of a periphery of the glazing unit,
wherein the glazing unit has no interlayer along at least part of one of its sides to create a lateral opening, a space between the two glass sheets forming a receiving area for the panel configured to slide in by being introduced through the lateral opening.

13. The sliding wall as claimed in claim 12, comprising two multiple glazing units arranged at a distance from each other in a coplanar manner and such that their lateral openings face each other, and
wherein the panel configured to slide is arranged between the multiple glazing units and is configured to be introduced into either of the glazing units through the corresponding lateral opening.

14. The sliding wall as claimed in claim 12, wherein the multiple glazing unit is fixed or sliding.

15. The sliding wall as claimed in claim 12, wherein the panel configured to slide is a monolithic glass or a rigid panel made of another material.

16. The sliding wall as claimed in claim 12, further comprising:
sliding means comprising at least one track arranged in the receiving space of the multiple glazing unit;
at least one continuation rail arranged outside of the glazing unit and level with the track; and
rolling means that are fixed to the panel configured to slide and that are configured to engage with the track and with the continuation rail.

17. The sliding wall as claimed in claim 12, wherein the wall, or the multiple glazing unit, comprises in the receiving space guiding means for the panel configured to slide, such as at least two projections that are spaced apart facing each other on inside face across the width of the interlayer.

18. The sliding wall as claimed in claim 16, wherein the track is fixed to inside faces of the glass sheets, and/or at the glazing unit interlayer, and/or is fixed to a profile attached to the glass sheets around the periphery of the glazing unit.

19. The sliding wall as claimed in claim 16, further comprising a fixed element that is butted against and coplanar with the multiple glazing unit and that supports the continuation rail.

20. The sliding wall as claimed in claim 19, wherein the fixed element comprises another multiple glazing unit comprising a flat interlayer arranged on the outside of and on all the periphery of the glazing unit, and fixed to the edge faces of the glazing unit, and the multiple glazing unit has its lateral opening on only part of its edge, the rest of the edge being closed by the interlayer, the fixed element being fixed to the receiving multiple glazing unit via their respective interlayers at the edge where the glazing unit has the lateral opening.

21. The sliding wall as claimed in claim 16, configured to be installed between a floor and ceiling of a room, the continuation rail configured to be fixed to the ceiling.

22. The sliding wall as claimed in claim 12, forming all or part of a partition, or forming a cupboard door.
